(19) United States
(12) Patent Application Publication
(10) Pub. No.: US 2013/0313801 A1
(43) Pub. Date: Nov. 28, 2013

(54) SECTIONAL OPTIMIZED TWIST BEAM

(71) Applicant: Young Lee, North York (CA)

(72) Inventor: Young Lee, North York (CA)

(73) Assignee: Multimatic Inc., Markham, CA (US)

(21) Appl. No.: 13/990,040

(22) PCT Filed: Nov. 28, 2011
(86) PCT No.: PCT/IB2011/055351

§ 371 Date: Aug. 12, 2013

Related U.S. Application Data
(60) Provisional application No. 61/417,876, filed on Nov. 29, 2010.

(51) Int. Cl. B60G 21/055

(52) U.S. Cl. CPC B60G 21/055
USPC 280/124.166

(57) ABSTRACT

A twist beam is manufactured from a tube and has a shorter sectional perimeter in the “V” or “U” shape center section and a longer sectional perimeter at the beam ends. The present disclosure therefore proposes to use a tubular member having a predetermined length. The tubular member is deformed at the center section of the tube into a “V” or “U” shape and then expanded at both end portions. This structure is formed using a closed die internal pressure forming process such as hydro-forming or blow molding or the like. The ends of the tubular member may also have a substantially oval or rectangular section. The tubular member of the present disclosure may also be heat treated in the closed die internal forming process to achieve a higher material strength. In this manner, the twist beam of the present disclosure is optimized to used the smallest possible section along its entire length, thus has a substantially lower mass and can be manufactured using less material and therefore at a substantially lower cost.

### SUMMARY

A twist beam is provided according to the embodiment(s) disclosed herein. The twist beam of the present disclosure is manufactured from a tube and has a shorter sectional perimeter in the “V” or “U” shape center section and a longer sectional perimeter at the beam ends. The present disclosure therefore proposes to use a tube having a predetermined length which is deformed in the center section and expanded on both end portions using a closed die internal pressure forming process such as hydroforming, blow molding or the like. The twist beam of the present disclosure may also be heat treated during the blow molding process to increase its strength and thus its fatigue performance. Accordingly, the twist beam of the present disclosure is optimized to used the smallest possible section along its entire length, thus has a substantially lower mass as current twist beams manufactured from tube and can be manufactured using less material and therefore at a substantially lower cost.

### BRIEF DESCRIPTION OF THE DRAWINGS

The present invention will now be described by way of example, with reference to the accompanying drawings:

FIG. 1 illustrates a perspective view of an embodiment of the twist beam (in the form of a tubular member) prior to undergoing the forming process.

FIG. 2 illustrates a perspective view of an embodiment of the twist beam after undergoing the forming process.

FIG. 3 illustrates a view of a cut-away, partial section of the twist beam of FIG. 2.

FIG. 4 illustrates a cross-sectional view of an embodiment of the twist beam along lines 4-4 in FIG. 2.

FIG. 5 illustrates a cross sectional view of an embodiment of the tubular member (prior to forming) along lines 5-5 of FIG. 1.

### DETAILED DESCRIPTION

The present disclosure provides a twist beam that may be manufactured from a tubular member and have a shorter sectional perimeter in the “V” or “U” shape center section and have a longer perimeter at the beam ends as shown in the non-limiting example of FIG. 2.

Accordingly, a first step of the present disclosure is to provide a tubular member that is precut to predetermined lengths. A second step of the present disclosure is to implement an internal pressure forming process such as, but not limited to hydro-forming or blow molding or the like to deform the center section of the tubular member into a “V” or “U” shape while expanding both a first end portion and a second end portion. In one non-limiting example, the tubular member is expanded from approximately an 80 mm diameter to approximately a 90 mm diameter. The desired shape is achieved using a closed die internal pressure forming process such as that in the non-limiting examples of hydro-forming or blow molding.

It is understood that the beam ends can also have a substantially oval or rectangular section after the forming process as shown in FIG. 6. It is also to be understood that the blow molding process of U.S. Pat. No. 6,261,392, which is hereby incorporated by reference, may be implemented. Accordingly, the present disclosure also includes the steps of heat treating the material to achieve a higher material strength and thus achieve a higher fatigue performance.

As shown in FIG. 2, the twist beam of the present disclosure is manufactured from a constant section tubular member and has a shorter sectional perimeter in the “V” or “U” shape center section while having a longer sectional perimeter at the twist beam ends by expanding the tubular member at the first end and the second end of the tubular member. The “V” or “U”-like shape is achieved using a closed die internal pressure forming process or the like.

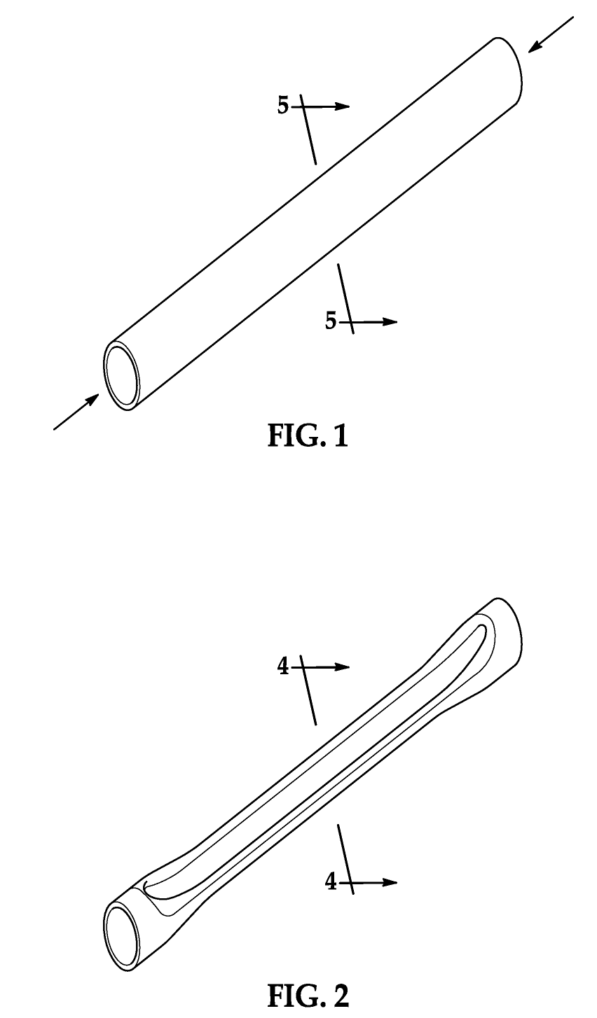

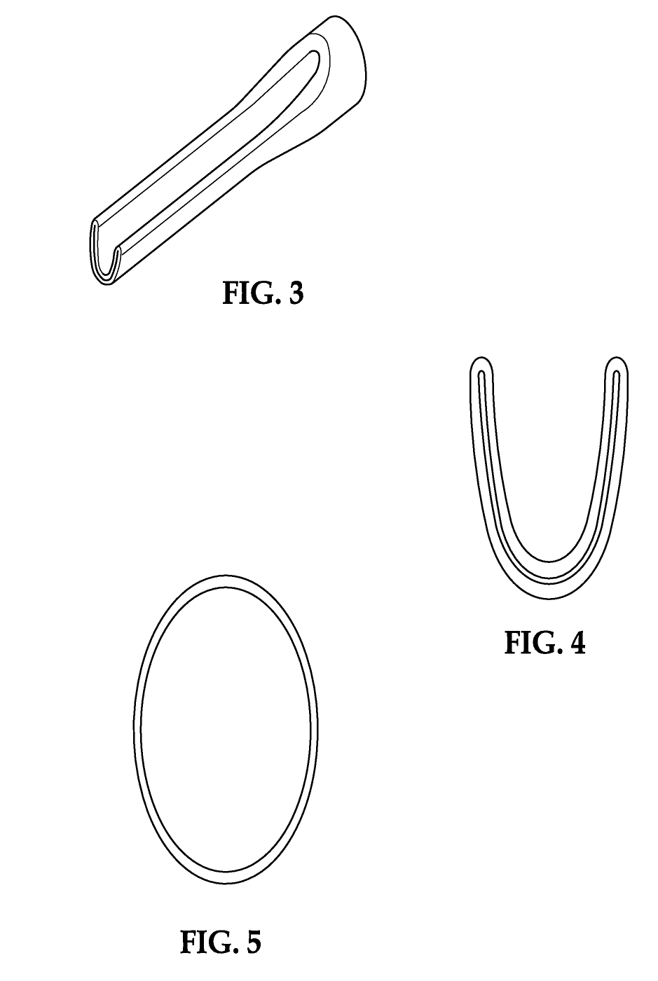

In one non-limiting example, the present disclosure therefore proposes to use an approximately 80 mm internal diameter tubular member that is precut to pre-determined lengths. Using a closed die internal pressure forming process such as but not limited to hydroforming, blow molding or the like in (shown in FIG. 1), the tubular member is deformed in the center section of the tubular member to a “V” or “U”-like shape as shown in FIG. 2. Furthermore, while in the closed die, the tubular member is expanded at both the first end portion and the second end portion of the tubular member to approximately 90 mm.

In a further non-limiting example, the present disclosure therefore proposes to use an approximately 80 mm internal diameter tubular member that is precut to pre-determined length. Using a blow molding process after the part has been heated to austenitic condition with an appropriate heat source such as a but not limited to conveyer furnace, induction furnace or the like, the tubular member is deformed in the centre section of the tubular member to a “V” or “U”-like shape as shown in FIG. 2. Furthermore, while in the closed die, the tubular member is expanded at both the first end portion and the second end portion of the tubular member to approximately 90 mm. Moreover while still in the closed die and after the forming is complete the part is quenched to increase its strength and fatigue performance.

Accordingly, the twist beam of the present disclosure is optimized to used the smallest possible section along its entire length, thus has a substantially lower mass as current twist beams manufactured from tube and can be manufactured using less material and therefore at a substantially lower cost relative to the prior art.

It will be appreciated by those skilled in the art that, although the invention has been described with reference to one or more preferred embodiments, the invention is not limited to these disclosed embodiments and that various alternative embodiments or modifications to the disclosed embodiments could be made without departing from the scope of the invention.

What is claimed is:

1. A twist beam for a suspension system consisting of a closed “V”-like or “U”-like centre section and a first end and a second end having one of a substantially rectangular, oval or circular shape, wherein the twist beam is manufactured by forming the twist beam from a constant section tubular member into one of a “V”-like or “U”-like shape in the center portion of the tubular member while simultaneously expanding the first end and the second end of the tubular member into one of a rectangular, oval or circular shape of a larger perimeter than the constant section tubular member

2. The twist beam of claim 1 wherein a closed die internal pressure forming process is implemented to manufacture the twist beam.

3. The twist beam of claim 2 wherein a heat treatment process is implemented in the closed die internal pressure forming process to increase it strength and fatigue performance
